(19) United States
(12) Patent Application Publication
(10) Pub. No.: US 2010/0294880 A1
(43) Pub. Date: Nov. 25, 2010

(54) ENGINE-PROPELLER DRIVE SYSTEM

(76) Inventor: Rafael Siviero, Bento Goncalves - RS (BR)

Correspondence Address: Husch Blackwell Sanders, LLP;Husch Blackwell Sanders LLP Welsh & Katz, 120 S RIVERSIDE PLAZA, 22ND FLOOR, CHICAGO, IL, 60606, US

(21) Appl. No.: 12/812,702

(22) PCT Filed: Dec. 9, 2008
(86) PCT No.: PCT/BR2008/000388

§ 371 Date: Jul. 26, 2010

(30) Foreign Application Priority Data
Mar. 17, 2008 (BR) PI 0800799-3

(51) Int. Cl. B64D 35/00

(52) U.S. Cl. 244/60

(57) ABSTRACT

Engine-propeller driving system comprising a device to transmit the power generated by an engine (5) to a propeller comprising an aircraft/vehicle (2) fuselage structure (1) that passes inside the propeller hub (3) so that the fuselage structure (1) becomes the turning axle of this aircraft/vehicle (2).

### TECHNICAL FIELD

The following descriptive report of this invention application refers to the development of an engine-propeller drive system, which consists in a device that transmits the power generated by an engine to a propeller, comprising the fuselage structure of an aircraft/vehicle, which passes inside the propeller hub, so that the fuselage structure becomes the turning axle of this aircraft/vehicle.

### STATE-OF-THE-ART

Propeller is an androgynous term that refers to a set of blades with the same center, which, when turned according to its axle. causes propulsion and each blade describes a path in the space which, in fact, is a geometric propeller. This propelling or driving instrument is generally coupled to a kind of engine that pushes what is around it (generally air or water), converting rotational power into translational power and displacing the object to which it is coupled (examples: aircraft, boats, hovercrafts, model aircrafts, and so on) or the fluid around it (example: vane). The propeller blades act as wings and produce power, complying with Bernoulli principle and with the 3^{rd} law of Newton, creating a pressure difference between both surfaces of the blades.

Currently, the propeller of an aircraft or boat is linked to a shaft aligned with the engine. Thus, the transmission occurs directly from the motor to the propeller. Usually, this propeller is arranged at a short distance from the motor. The document BR 9.301.450 of WU et all. (1993) shows a single-engine airplane, where the engine was placed at a good distance from the propeller for a better use of the air flow on the aircraft, thus improving significantly the cooling and maintenance of its engine, and with it, the center of gravity remained in a privileged position, in the center of the aircraft. But even in this arrangement, the propeller remains with the drive directly from the engine to the propeller, since they have the same axle.

A body that turns at a high speed tends to keep the position of its rotating axle unchanged, and the highest the rotating speed and the body weight, the greatest the effect. However, when the axle is forced to change the position due to a foreign force, it displaces as if the power was applied to a point located at 90°, in the direction of the rotation.

The phenomenon can be easily verified making a bicycle wheel rotating around its axis. As soon as it turns quickly, it tilts the axle quickly to the left. The wheel will tilt with some difficulty, not to the side to which one intends to take it, but upwards or downwards, as if it has been moving from the right to the left or from the left to the right.

This special reactive force is referred as gyroscopic effect, a force that is applied on a normal axis to the rotating axle, and is evidenced by means of a device named gyroscope. If, at a certain point of the moving gyroscope a pressure is exerted, this will be reflected at a point located at 90°, in the direction of the rotation.

A propeller turning at high speed constitutes a gyroscopic mass, being subject, therefore, to those effects.

### Problems of the Art

In the current aircraft/vehicles, this gyroscopic effect is quite known, being responsible for vibrations and for forces opposite to the direction changing movements. Of course, there are ways to reduce these vibrations and opposite forces, but they will not be approached since they are not included in the scope of this work.

Thus, the problem that we attempt to solve with this engine-propeller is the gyroscopic effect on the engine axle.

### Proposed Solution

Thus, and considering the statements made on the state-of-the art previously discussed, one of the objectives of this application of the invention, that is, the development of an engine-propeller driving system, where one may transmit the force generated by one engine to a propeller, comprising the fuselage structure of an aircraft/vehicle, which passes inside of the propeller hub, so that this structure becomes the rotating axis of the aircraft propeller. Since the structure, where the propeller is inserted is quite huge, with a length and thickness greater than a conventional axle would have, the gyroscopic effect is attenuated in the engine. Another aspect that reduces the effect is the fact that the propeller is not lined up with the engine. The propeller is at a proper position, and the force is transmitted through the use of a belt/chain/gear or other appropriate devices. The change in the position of the propeller in relation to the engine provides more freedom in the construction of an aircraft, since one can position the engine and the propeller in different locations, which are not required to be aligned, besides improving the flow of air on the empennage/tailplane, improving the position of the gravity center and favors the aesthetics of the vehicle.

### DESCRIPTION OF THE FIGURE

The characterization of this application for an invention patent is made through a drawing representing the engine-propeller driving system, so that the product can be fully reproduced by an appropriate technique, allowing the full characterization of the claimed object functionality.

The descriptive portion of the report is based on the formulated figure, which expresses the best or the preferred way to make the conceived product, which presents a detailed and consecutive numeration, and clarifies aspects that can be implied in the adopted representation, in order to determine clearly the claimed protection.

This FIGURE is merely illustrative, and can present variations since they do not get distant from the initial claim.

In this case, we have:

FIG. 1 is a schematic representation of the proposed drive, showing a propeller coupled to an aircraft fuselage structure, which is moved by a belt connected to an engine.

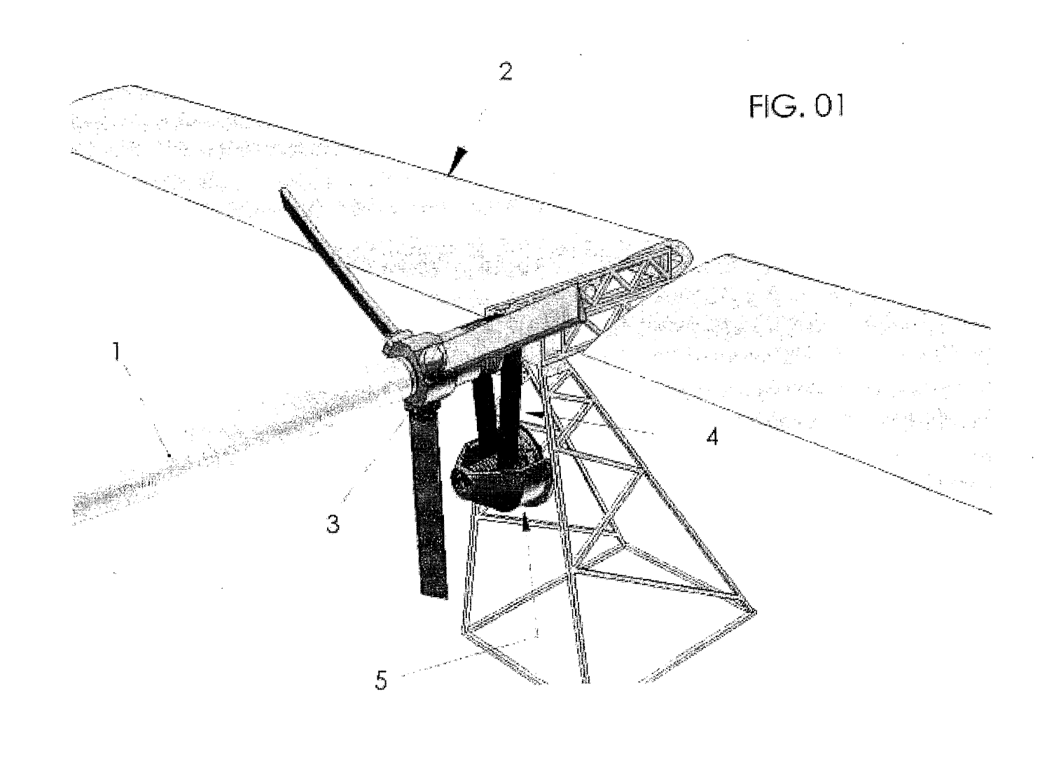

### DESCRIPTION OF THE INVENTION

A preferred art comprising an aircraft (2) fuselage structure (1), that passes inside the propeller hub (3), being this propeller operated by means or by a belt/chain/gear (4) actuated by an engine (5), with the turning axle of the mentioned propeller (3) not aligned to the engine (5).

The structure of the fuselage (1) can be arranged in any position proper to the drive, and the engine (5) is located in another location of the aircraft.

The propelling engine (5) of the aircraft can be internal explosion type, electric drive or any other type that can generate a driving force used by a propeller.

1- ENGINE-PROPELLER DRIVING SYSTEM comprising an aircraft/vehicle (2) fuselage structure (1), that passes inside the propeller hub (3), being this propeller operated by means of a belt/chain/gear (4) actuated by an engine (5), with the turning axle of the mentioned propeller (3) not aligned to the engine (5).

2- ENGINE-PROPELLER DRIVING SYSTEM according to claim 1 and characterized by the fact that the structure of the fuselage (1) can be arranged in any position proper to the drive, being the motor (5) located in any another point of the aircraft.

3- ENGINE-PROPELLER DRIVING SYSTEM, in accordance with claim 1 and characterized by the fact that the propelling engine (5) of the aircraft being internal explosion type, electric drive or any other kind compatible with a propeller.
